(19) United States
(12) Patent Application Publication
(10) Pub. No.: US 2013/0112278 A1
(43) Pub. Date: May 9, 2013

(54) BISTABLE PULSE SOLENOID VALVE CONTROL SYSTEM AND METHOD

(71) Applicant: Shanghai Kohler Electronics, Ltd., Shanghai (CN)

(72) Inventors: Zhongmin Chen, Shanghai (CN); Pengcheng Gao, Shanghai (CN)

(73) Assignee: Shanghai Kohler Electronics, Ltd., Shanghai (CN)

(21) Appl. No.: 13/672,523

(22) Filed: Nov. 8, 2012

(30) Foreign Application Priority Data
Nov. 9, 2011 (CN) 201110352123.8

(51) Int. Cl. F16K 31/02; E03C 1/05

(52) U.S. Cl. CPC F16K 31/02; E03C 1/055
USPC 137/2; 251/129.15; 137/560; 4/300

(57) ABSTRACT

The present invention provides a bistable pulse solenoid valve control system and method. The control system includes a bistable pulse solenoid valve having a coil current, and including a coil frame, a coil having a magnetic flux, at least two permanent magnets, a valve core disposed inside the coil frame, and a frame configured to encapsulate the permanent magnets, the coil, the valve core, and the coil frame. The system also includes a main control circuit, a polarity conversion control circuit, and a drive current sampling detection circuit. The main control circuit is configured to generate a control signal and the polarity conversion control circuit is configured to control the direction and power on-off time of the coil current.

### CROSS-REFERENCE TO RELATED APPLICATIONS

The present application claims the benefit of and priority to Chinese Patent Application 201110352123.8, filed Nov. 9, 2011, the entire contents of which are hereby incorporated by reference in their entirety.

### FIELD

The present disclosure relates generally to sanitary and bath products, and more particularly to a bistable pulse solenoid valve control system and method for sanitary and bath products.

### BACKGROUND

In conventional sanitary and bath products, and particularly in automatic faucets and urinals, an infrared sensing device is typically used along with a solenoid valve to control the water supply. These types of automated systems may use batteries as a power source, making the associated devices more portable and less dependent on electricity or other power sources. However, batteries have limited electrical energy, meaning that energy consumed by these devices is at a premium. In light of the small amount of electrical energy available in the batteries, and the increased emphasis on energy savings within the industry, it may be desirable to lower the electrical energy consumption of these types of automated systems.

Conventional valve control systems may include a coil that is configured to power on and off, generating a force to open or close the solenoid valve, and thus turning the associated device on or off. In these systems, it may be difficult to accurately determine when the coil should be powered on or off. If the power to the coil is turned off too early, the valve core may not completely reach the open position, resulting in a failed operation. To prevent this scenario, a sufficiently long power-off period is necessary for the valve control system. The power-off period consumes power, however, and if the power-off period is too long, unnecessary power is consumed. On the other hand, a power-off period that is too short may not ensure that the valve reaches the open position. The same is true of the power-on period for the valve.

Energy consumed by the open-close operation of a solenoid valve (i.e., the coil power-on period) accounts for most of the energy consumed by the entire valve control system. Therefore, it may be helpful to effectively lower the power consumption by the solenoid valve, thereby lowering the entire system's power consumption, while ensuring the reliable opening and closing of the solenoid valve.

Due to differences in solenoid valve production technologies, water pressures and water qualities of application environments, the power-on time is different for different solenoid valves. To avoid failed operations and achieve reliable solenoid valve operations, therefore, a certain margin is typically reserved for the power-on period of solenoid valves. Conventional valve control systems may take up to 14 ms to open or close the valve. A large portion of this time is wasted on the stated “margin.”

### SUMMARY OF THE INVENTION

An embodiment of the present disclosure relates to a bistable pulse solenoid valve control system. The system includes a bistable pulse solenoid valve having a coil current. The bistable pulse solenoid valve includes a coil frame having at least two sides, and having an external wall, a coil having a magnetic flux, the coil being wrapped around the external wall of the coil frame, at least two permanent magnets disposed at least at two opposite sides of the coil, a valve core disposed inside the coil frame, and a frame configured to encapsulate the permanent magnets, the coil, the valve core, and the coil frame.

In this embodiment, the bistable pulse solenoid valve control system also includes a main control circuit, the main control circuit configured to receive induction signals and to transmit pulse signals, and a polarity conversion control circuit configured to receive pulse signals from the main control circuit, and to change the voltage direction of the coil based on the polarity of the pulse signals, thereby changing the current direction in said coil. The bistable pulse solenoid valve control system also includes a drive current sampling detection circuit configured to read and collect the values of the current passing through the bistable pulse solenoid valve, and to develop sampling results. In this embodiment, the main control circuit is configured to receive the sampling results, and to generate a corresponding control signal, and the polarity conversion control circuit is configured to receive the control signal, and to control the direction and power on-off time of the coil current based on the control signal.

Another embodiment of the present disclosure relates to an automated water spray device. The automated water spray device includes a bistable pulse solenoid valve control system. The bistable pulse solenoid valve control system includes a bistable pulse solenoid valve having a coil current, the bistable pulse solenoid valve including a coil frame having at least two sides, and having an external wall, a coil having a magnetic flux, the coil being wrapped around the external wall of the coil frame, at least two permanent magnets disposed at least at two opposite sides of the coil, a valve core disposed inside the coil frame, and a frame configured to encapsulate the permanent magnets, the coil, the valve core, and the coil frame.

In this embodiment, the bistable pulse solenoid valve control system also includes a main control circuit, the main control circuit configured to receive induction signals and to transmit pulse signals, and a polarity conversion control circuit configured to receive pulse signals from the main control circuit, and to change the voltage direction of the coil based on the polarity of the pulse signals, thereby changing the current direction in said coil. The bistable pulse solenoid valve control system also includes a drive current sampling detection circuit configured to read and collect the values of the current passing through the bistable pulse solenoid valve, and to develop sampling results. In this embodiment, the main control circuit is configured to receive the sampling results, and to generate a corresponding control signal, and the polarity conversion control circuit is configured to receive the control signal, and to control the direction and power on-off time of the coil current based on the control signal.

Another embodiment of the present disclosure relates to a method for controlling the direction and on-off time of the coil current of a bistable pulse solenoid valve. The method includes providing a bistable pulse solenoid valve having a coil current. The bistable pulse solenoid valve includes a coil frame having at least two sides, and having an external wall, a coil having a magnetic flux, the coil being wrapped around the external wall of the coil frame, at least two permanent magnets disposed at least at two opposite sides of the coil, a valve core disposed inside the coil frame, and a frame configured to encapsulate the permanent magnets, the coil, the valve core, and the coil frame.

In this embodiment, the method also includes receiving induction signals by a main control and then transmitting pulse signals, and receiving the pulse signals from the main control circuit by a polarity conversion control circuit, and changing the voltage direction of the coil based on the polarity of the pulse signals, thereby changing the current direction in the coil. The method also includes collecting and reading the current passing through the bistable pulse solenoid valve by using a drive current sampling detection circuit, and developing sampling results, interpreting the sampling results and generating a corresponding control signal by using the main control circuit, and controlling the direction and on-off time of the coil current of the bistable pulse solenoid valve by using the polarity conversion control circuit to receive and interpret the control signal.

### BRIEF DESCRIPTION OF THE DRAWINGS

FIG. 1 illustrates the structure of a conventional bistable pulse solenoid valve.

FIG. 2 illustrates the magnetic field of the two permanent magnets when the coil in the structure of FIG. 1 is not powered on.

FIG. 3 illustrates the magnetic field of the two permanent magnets when the coil in the structure shown in FIG. 1 is powered on.

FIG. 4 illustrates the circuit module of the application of a conventional bistable pulse solenoid valve.

FIG. 5 illustrates the current-time curve for the coil of a bistable pulse solenoid valve of the present disclosure during the power-on process, according to an exemplary embodiment.

FIG. 6 illustrates the circuit module of a circuit control system of the bistable pulse solenoid valve of the present disclosure, according to an exemplary embodiment.

FIG. 7 is the system circuit diagram of the drive current sampling detection circuit, including a ZXCT1009F IC chip as the current detection chip, according to an exemplary embodiment.

FIG. 8 illustrates a current-time curve under an abnormal condition.

FIG. 9 illustrates a current-time curve under an abnormal condition.

FIG. 10 illustrates a current-time curve under an abnormal condition.

### DETAILED DESCRIPTION OF THE PREFERRED EMBODIMENTS

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

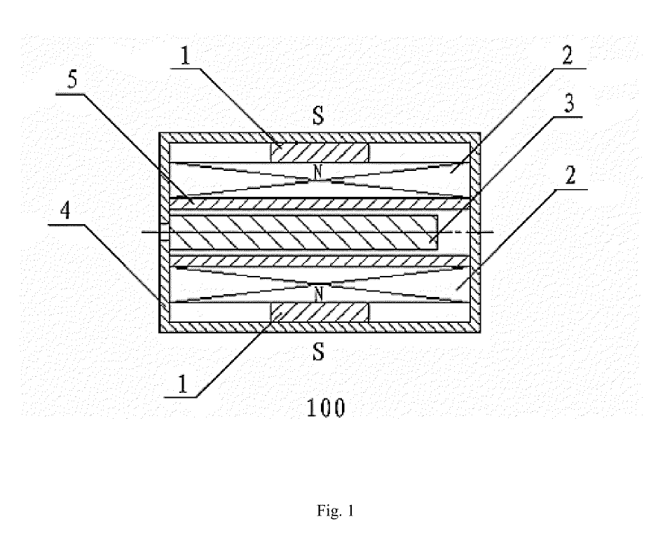

FIG. 1 illustrates the structure of a conventional bistable pulse solenoid valve 100. As shown in FIG. 1, the conventional bistable pulse solenoid valve 100 includes permanent magnets 1, a coil 2, a valve core 3, a frame 4, and a coil frame 5. The frame 4 encapsulates the permanent magnets 1, the coil 2, the valve core 3 and the coil frame 5. The valve core 3 is disposed inside the coil frame 5, and the coil 2 is wound around the external wall of the coil frame 5. The two permanent magnets 1 are disposed at two opposite sides of the coil 2. In exemplary embodiments, the N pole of the permanent magnet 1 is proximate to the coil 2, and the S pole is far away from the coil 2. However, in other embodiments, the bistable pulse solenoid valve 100 components may be in any configuration suitable to the particular application.

FIG. 2 illustrates the distribution of the magnetic field of the two permanent magnets when the coil 2 of FIG. 1 is not powered on. As shown in FIG. 2, magnetic lines of force emanate from the two permanent magnets 1 above and below the valve core 3. The magnetic lines of force from each magnet 1 are evenly divided into two groups that run through the valve core 3. One group of the magnetic lines of force runs horizontal and to the left of the magnet 1, and the other group of the magnetic lines of force runs horizontal and to the right of the magnet 1.

The valve core 3 is in the absolute center of the frame 4 relative to the permanent magnets 1 in the illustrated embodiment of FIG. 2, but the valve core 3 may be in any other position in other exemplary embodiments. When the valve core 3 deviates to the left relative to the permanent magnets 1, the group of the magnetic lines of force that runs to the left will exert a leftward magnetic force on the valve core 3 greater than the rightward magnetic force exerted by the group of the magnetic lines of force that runs to the right of the valve core 3. When this happens, the combined magnetic force on the valve core 3 is to the left, such that the valve core 3 slides to the left until it stops at the left border of the frame 4. Likewise, when the valve core 3 deviates to the right relative to the permanent magnets 1, the valve core 3 will slide to the right under the influence of the combined magnetic force until it stops at the right border of the frame 4. In exemplary embodiments, the valve core 3 may also rest at the left border of the frame 4 when the solenoid valve is not powered on and in the closed state.

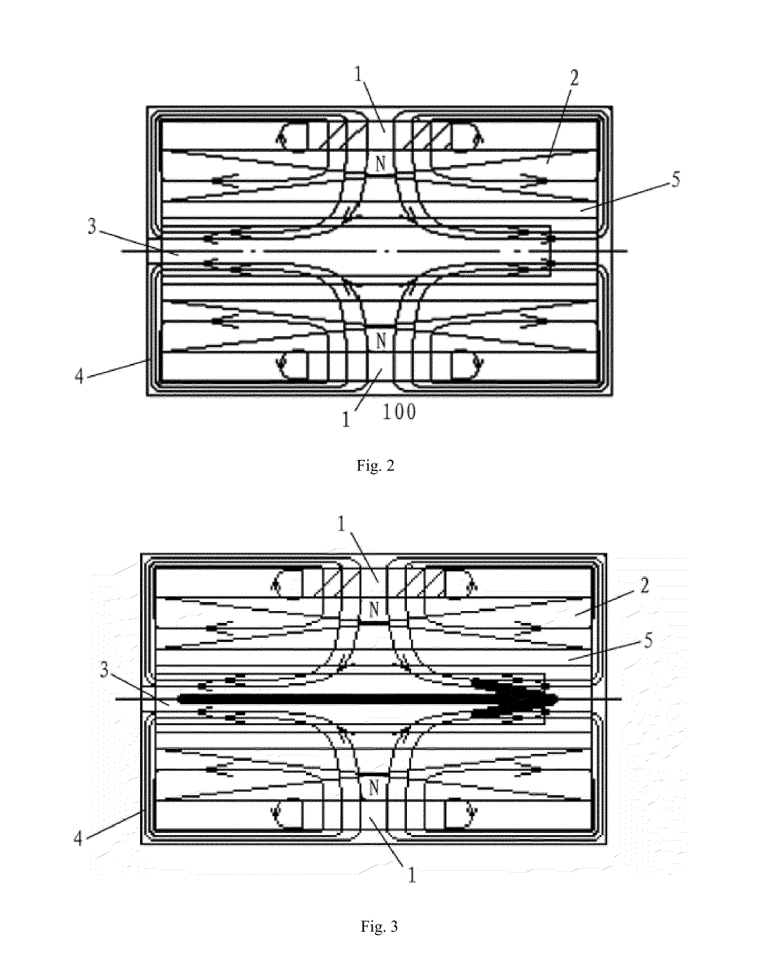

FIG. 3 illustrates the distribution of the magnetic field when the coil 2 in the structure shown in FIG. 1 is powered on. In FIG. 3, the direction of the current on the top coil 2 is outwardly perpendicular to the paper, and the direction of the current on the bottom coil 2 is inwardly perpendicular to the paper. According to Ampere's rule, a magnetic field that is parallel to the valve core 3 from left to the right is generated inside the coil 2. As a result, the valve core 3 will be subject to an electromagnetic force with a rightward direction according to FIG. 3, and the direction of this electromagnetic force is opposite to the combined permanent magnetic force exerted by the permanent magnets 1 on the valve core 3, in this exemplary embodiment.

According to the illustrated embodiment of FIG. 3, the current in the coil 2 gradually increases once the coil 2 is turned on. In exemplary embodiments, the generated electromagnetic field is weak in the initial phase since the current is low, leading to a relatively weak electromagnetic force on the valve core 3. During this initial phase, the rightward electromagnetic force on the valve core 3 is still weaker than the leftward combined permanent magnetic force exerted by the permanent magnets 1 on the valve core 3. The rightward electromagnetic force on the valve core 3 is therefore unable to drag the valve core 3 to move to the right. In such a circumstance, the valve core 3 stays at the left border of the frame 4, according to FIG. 3.

Still referring to FIG. 3, the current in the coil 2 may continue to increase. As the current increases, the generated electromagnetic field increases with it, increasing the electromagnetic force on the valve core 3. When the rightward electromagnetic force on the valve core 3 is greater than the leftward combined permanent magnetic force exerted by the permanent magnets 1 on the valve core 3, the valve core 3 may be moved to the right. At this point, the direction of the combined permanent magnetic force exerted by the permanent magnets 1 on the valve core 3 is still to the left, but may be overcome by the electromagnetic force generated by the coil 2.

As the electromagnetic force increases, the valve core 3 continues to move to the right, according to FIG. 3. As the valve core 3 moves to the right, the center of the valve core 3 passes the permanent magnets 1 and is positioned on the right side of the permanent magnets 1. The direction of the combined permanent magnetic force by the permanent magnets 1 may then change, exerting a force in the right direction on the valve core 3. At this point, the combined permanent magnetic force is in the same direction as the electromagnetic force on the valve core 3. In such a circumstance, the valve core 3 will be pulled to the right by the joint action of the combined permanent magnetic force of the permanent magnets 1 and the electromagnetic force moving in the same direction. The valve core 3 will move to the right in this way until it reaches the right border of the frame 4.

If the coil 2 is powered off and has no current flowing through, the electromagnetic force exerted by the coil 2 on the valve core 3 disappears. Without the electromagnetic force exerted by the coil 2, the valve core 3 will steadily stay at the right border of the frame 4 under the influence of only the rightward combined permanent magnetic force. At this moment, the solenoid valve may be in the open state.

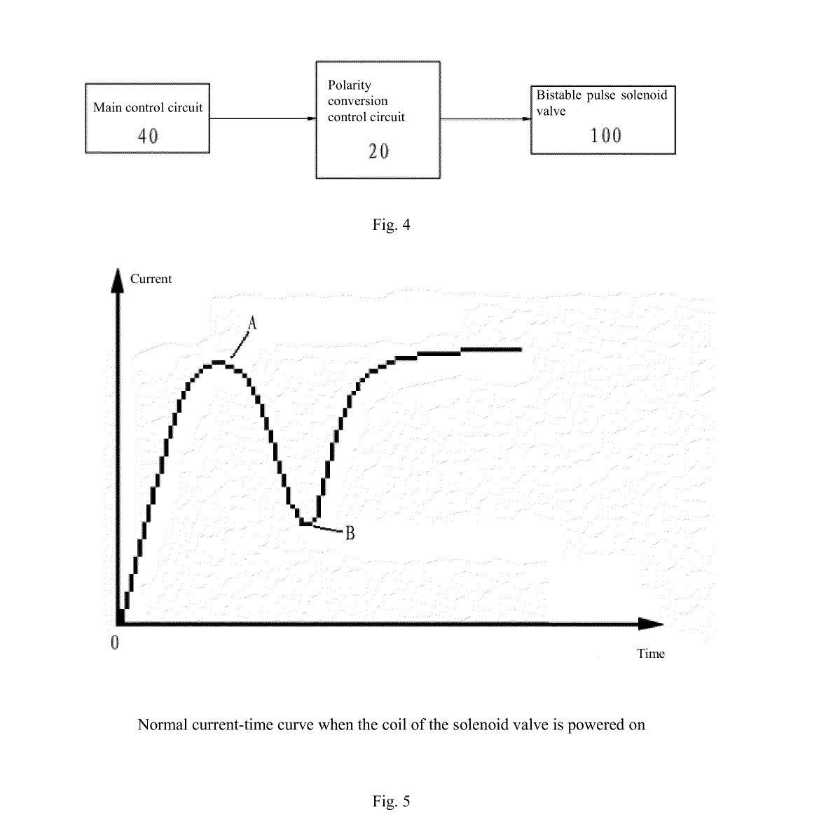

FIG. 4 illustrates the circuit module for a conventional bistable pulse solenoid valve. As shown in FIG. 4, the main control circuit 40 is intended to receive induction signals and to transmit positive pulses or negative pulses to the polarity conversion control circuit 20. In exemplary embodiments, the polarity conversion control circuit 20 changes the voltage direction of the coil 2 of the bistable pulse solenoid valve based on the polarity of the received pulse signals. The polarity conversion control circuit 20 also provides a valve opening signal or a valve closing signal, thereby changing the current direction in the coil 2 in the solenoid valve 100.

When the coil 2 is powered on, the magnetic flux generated by the coil 2 may be increased if a magnetic core is added to the coil 2. The axial movement of the magnetic core inside the coil 2 will also change the magnetic flux in the coil 2. According to Faraday's Law of Electromagnetic Induction, the change to the magnetic flux will result in induced electromotive force in the coil 2 that is opposite to the direction of the originally applied voltage.

FIG. 5 illustrates the current-time curve for the coil 2 during the power-on process of a bistable pulse solenoid valve, according to an exemplary embodiment. As shown in FIG. 5, in the initial phase, the current in the coil 2 gradually increases with time. However, the electromagnetic force exerted by the coil 2 on the valve core 3 is weaker than the combined permanent magnetic force exerted by the permanent magnets 1 on the valve core 3. The electromagnetic force exerted by the coil 2 is therefore insufficient to push the valve core 3 to move. In this phase, the valve core 3 remains still and thus, the magnetic flux in the coil 2 does not change. Only the current in the coil 2 increases along with the increase of the applied voltage, in this initial phase.

As the current in the coil 2 gradually increases, the rightward electromagnetic force (according to FIG. 1) exerted by the coil 2 on the valve core 3 becomes greater than the leftward combined permanent magnetic force (according to FIG. 1) on the valve core 3. At this moment, the current inflection point A is recorded. The inflection point A is identified on the graph of FIG. 5 at a local maximum. At the moment A occurs, the voltage applied on the coil 2 stops increasing, and the valve core 3 begins to move to the right. The rightward movement of the valve core 3 in the coil 2 leads to changes to the magnetic flux in the coil 2. According to Faraday's Law of Electromagnetic Induction, an induced electromotive force will appear in the coil 2. The polarity of the induced electromotive force is opposite in direction to the originally applied voltage, which decreases the total voltage in the coil 2. As a result, the current passing through the coil 2 is reduced. As shown in FIG. 5, the current in the coil 2 begins to decrease after the inflection point A, according to exemplary embodiments.

As time increases, the valve core 3 continues to move to the right (according to FIG. 1) until the valve core 3 reaches the right border of the frame 4 and stops. At that moment, the valve core 3 no longer moves in the coil 2, and the magnetic flux in the coil 2 no longer changes. Correspondingly, the induced electromotive force will disappear in the coil 2. When the induced electromotive force disappears, the current in the coil 2 reaches the inflection point B. The inflection point B is identified on the graph of FIG. 5 at a local minimum. Starting from the inflection point B, the induced electromotive force disappears, and the total voltage on the coil 2 begins to gradually increase again. The increase in voltage leads to another gradual increase of current in the coil 2.

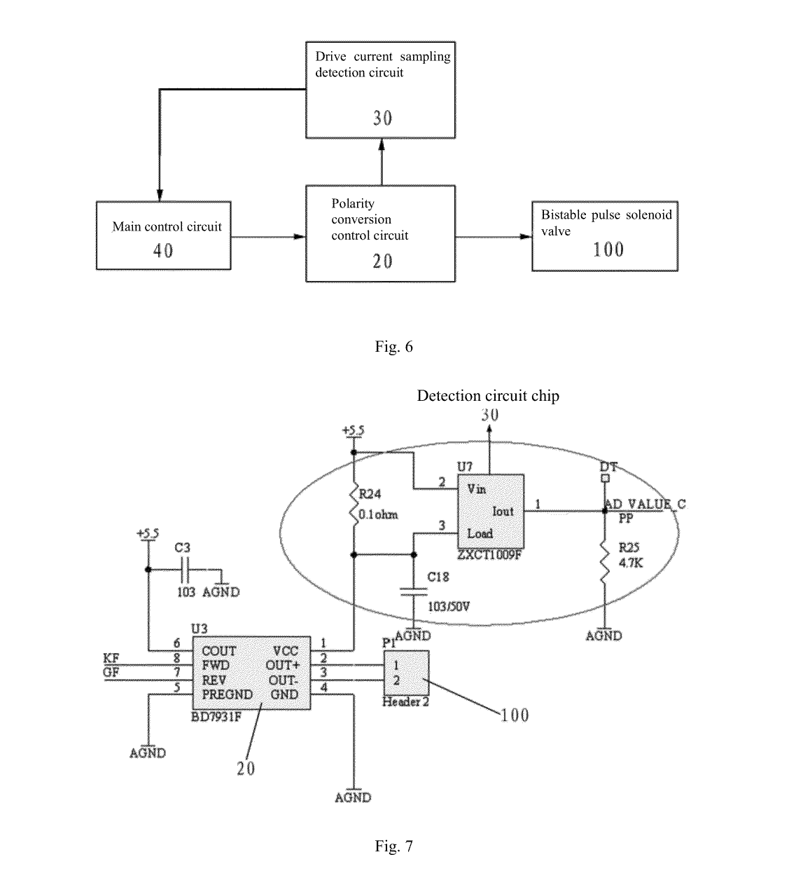

According to the current-time curve shown in FIG. 5, if the moment of the current inflection point B (i.e. the moment when the valve core 3 moves to another border within the frame) can be captured, and the power is turned off at this moment, the margin can be effectively saved, reducing the power consumption of the solenoid valve 100. The valve control system of the present disclosure includes a drive current sampling detection circuit 30 (shown in FIG. 6), according to an exemplary embodiment. The drive current sampling detection circuit 30 is intended to capture the current inflection point B, thereby saving the margin and reducing the power consumption of the solenoid valve.

FIG. 6 illustrates the circuit module of the circuit control system of the present disclosure, according to an exemplary embodiment. As shown in FIG. 6, the drive current sampling detection circuit 30 collects and reads samples of current passing through the bistable pulse solenoid valve 100, and transmits the sampling results to the main control circuit 40. The main control circuit 40 generates a corresponding control signal after judging the sampling results, and transmits the control signal to the polarity conversion control circuit 20. Based on the corresponding control signal, the polarity conversion control circuit 20 controls the direction and on-off time of the coil current of the bistable pulse solenoid valve.

For instance, the main control circuit 40 may instantly capture the current inflection point B based on the sampling results provided by the drive current sampling detection circuit 30. The main control circuit 40 may then transmit a corresponding control signal to the polarity conversion control circuit 20. Subsequently, the polarity conversion control circuit 20 may turn off the power to the bistable pulse solenoid valve 100, in exemplary embodiments.

The drive current sampling detection circuit 30 may utilize a regular current detection chip to collect and read current samples, in exemplary embodiments. However, the drive current sampling detection circuit 30 is not limited to a specific type of current detection chip. The drive current sampling detection circuit 30 may also utilize any other type of detection device, depending on what is suitable for the particular application.

FIG. 7 shows the system circuit diagram of the drive current sampling detection circuit 30, according to an exemplary embodiment. In this embodiment, the drive current sampling detection circuit 30 is connected to the bistable pulse solenoid valve 100 via the polarity conversion control circuit 20. In this embodiment, the polarity conversion control circuit 20 is configured to utilize a ZXCT1009F IC chip as the current detection chip. The ZXCT1009F IC chip is a high-end current sensing monitoring chip with the voltage input range of 2.5-20 V, and its output voltage can be adjusted as needed. Terminals 1 and 2 of the ZXCT1009F IC chip are input terminals. However, the polarity conversion control circuit 20 may utilize any other component to collect and read current samples, as is suitable for the particular application.

Still referring to FIG. 7, the polarity conversion control circuit 20 may utilize a BD7931F IC chip, in exemplary embodiments. In these embodiments, the terminal 1 of the chip is connected to the power source, terminals 2 and 3 are connected to the input terminal of the solenoid valve 100, terminals 4 and 5 are grounded, terminal 6 is connected to a logic power source, and terminals 7 and 8 are connected to the valve-opening, valve-closing signal output terminals of the main control circuit 40.

The ZXCT1009F IC chip may convert the current of the solenoid valve 100 to a voltage U_{ab} for inputting into terminals 2 and 3 of the chip. However, the polarity conversion control circuit 20 may utilize any other component to convert the current of the solenoid valve 100 to a voltage, as may be suitable for the particular application. In exemplary embodiments, the voltage U_{ab} is processed by the chip and converted to the current Iₒᵤₜ for output. Except for the quiescent current, a certain relationship exists between all other voltages U_{ab} and currents Iₒᵤₜ. The following table is an example of the relationship between the voltage U_{ab} and the current Iₒᵤₜ:

| U_{ab} | Iₒᵤₜ |
|---|---|
| 0 V | 4 μA |
| 10 mV | 104 μA |
| 100 mV | 1.002 mA |
| 200 mV | 2.0 mA |
| 1 V | 9.98 mA |

Still referring to the illustrated embodiment of FIG. 7, when the resistance R24 of the connected power source is known, the voltage U_{ab} is directly proportional to the current of the solenoid valve 100. Therefore, a certain relationship may exist between the current Iₒᵤₜ and the current passing through the solenoid valve 100.

In exemplary embodiments, the output current from the drive current sampling detection circuit 30 may pass through an analog to digital (AD) conversion circuit to obtain a digital value. The digital value is then fed back to the main control circuit 40. When the main control circuit 40 receives feedback showing that the current is at the inflection point B, it may be configured to turn off the power for the solenoid valve 100. When the current is at the inflection point B, the main control circuit 40 thereby recognizes that the valve core 3 has moved to its position. The main control circuit 40 may then open or close the valve 100, and at the same time reduce the power consumption of the valve 100.

The time to open and close the solenoid valve 100 is also closely related to the water pressure within the circuit 40. With the power supply at 5.5 V, the time to open or close the valve under typical states (including no-load, 2 kg water pressure, 5.5 kg water pressure and 8 kg water pressure states) may be measured through current sampling and inflection determination techniques. An example of what these times expected times might be, in one exemplary embodiment, is shown in the table below:

| Pressure | Open Valve | Close Valve |
|---|---|---|
| No load | 8 ms− | 7 ms− |
| 2 KG | 8 ms | 7 ms |
| 5.5 KG | 8 ms | 7 ms |
| 8 KG | 8 ms+ | 7 ms+ |

As shown in the table above, under a water pressure from 0-8 kg, the power-on time for the solenoid valve 100 of the present disclosure is only 8 ms to open the valve 100 and 7 ms to close the valve 100.

In conventional valve control systems, it may take approximately 14 ms for the valve to open or close. In exemplary embodiments, the valve control system of the present disclosure is intended to save about half of the time by opening the valve in approximately 8 ms, and closing the valve in approximately 7 ms. The valve control system of the present disclosure is intended to consume only half of the electrical power of a typical conventional valve control system. The valve control system of the present disclosure is thereby intended to extend the battery life of the valve control system by about 33%.

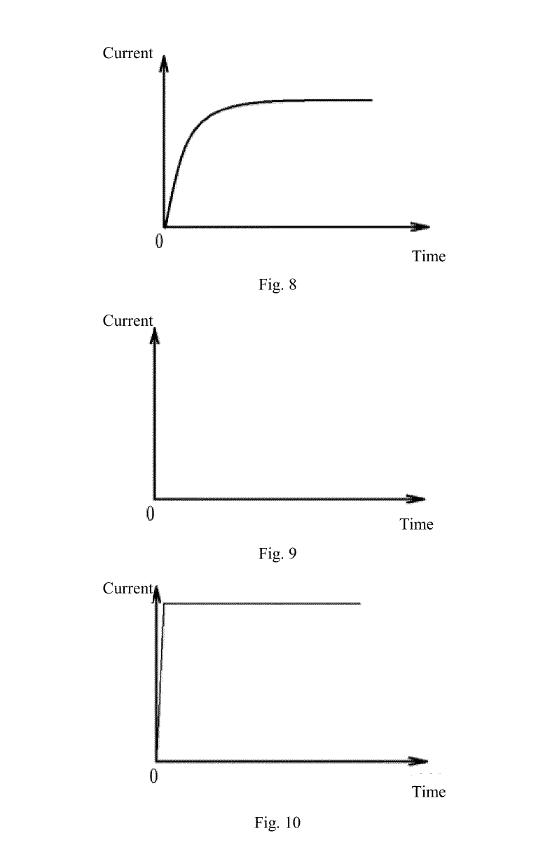

In some embodiments, the drive current sampling detection circuit 30 may be configured to detect current changes for the purpose of detecting faults. If current change is abnormal within the valve control system, the drive current sampling detection circuit 30 may be configured to interpret the abnormal current changes, and to then detect abnormal conditions of the solenoid valve 100. Examples of abnormal conditions within a valve control system are shown in FIGS. 8-10.

Referring now to FIGS. 8-10, three current-time curves are shown, according to abnormal conditions. FIG. 8 shows a current-time curve for when the valve core 3 is blocked halfway. As shown in FIG. 8, if the valve core 3 is blocked halfway, then the valve core 3 no longer moves. As a result, the magnetic flux in the coil 2 will no longer change when the valve core 3 moves halfway. Correspondingly, the induced electromotive force that is opposite to the originally applied voltage will no longer be generated, and the coil current will not decrease.

FIG. 9 shows a current-time curve for when the coil 2 is broken or the drive chip is damaged, leading to a power-off. As shown in FIG. 9, if this abnormal condition occurs, no current will be generated.

FIG. 10 shows a current-time curve for when the coil 2 is shorted or the drive chip is damaged, leading to a short circuit. As shown in FIG. 10, once the power is turned on in this abnormal condition, the current increases rapidly and is far higher than the current value under normal conditions.

The current-time curves for the above three abnormal conditions are markedly different from the normal condition. The current sampling detection circuit 30 is configured to identify these three abnormal conditions. The drive current sampling detection circuit 30 is also configured to identify other possible abnormal conditions.

The bistable pulse solenoid valve control system and method of the present disclosure are intended to reduce the time necessary to open and close the valve. This time saved may also reduce power consumption within the valve 100, and extend the service life of the batteries used in the system. Moreover, the drive current sampling detection circuit 30 of the present disclosure is configured to identify various abnormal conditions that are likely to occur in the operation of the solenoid valve 100.

What is claimed is:

1. A bistable pulse solenoid valve control system, comprising:
a bistable pulse solenoid valve having a coil current, the bistable pulse solenoid valve comprising:
a coil frame having at least two sides, and having an external wall;
a coil having a magnetic flux, the coil being wrapped around the external wall of the coil frame;
at least two permanent magnets disposed at least at two opposite sides of the coil;
a valve core disposed inside the coil frame;
a frame configured to encapsulate the permanent magnets, the coil, the valve core, and the coil frame;
a main control circuit, the main control circuit configured to receive induction signals and to transmit pulse signals;
a polarity conversion control circuit configured to receive pulse signals from the main control circuit, and to change the voltage direction of the coil based on the polarity of the pulse signals, thereby changing the current direction in said coil;
a drive current sampling detection circuit configured to read and collect the values of the current passing through the bistable pulse solenoid valve, and to develop sampling results;
wherein the main control circuit is configured to receive the sampling results, and to generate a corresponding control signal; and
wherein the polarity conversion control circuit is configured to receive the control signal, and to control the direction and power on-off time of the coil current based on the control signal.

2. The bistable pulse solenoid valve control system of claim 1, further comprising:
a first inflection point A, being the instant current generated when the valve core begins to move from the first end of the frame;
a second inflection point B, being the instant current when the valve core stops at the second end of the frame opposite to the first end;
wherein the main control circuit is configured to transmit a corresponding control signal to the polarity conversion control circuit at the moment of the second inflection point B, and subsequently the polarity conversion control circuit is configured to turn off the power to the bistable pulse solenoid valve.

3. The bistable pulse solenoid valve control system of claim 1, wherein the drive current sampling detection circuit comprises a current detection chip, and the current detection chip is configured to read current samples.

4. The bistable pulse solenoid valve control system of claim 3, wherein the drive current sampling detection circuit is integrated with the polarity conversion control circuit.

5. The bistable pulse solenoid valve control system of claim 3, wherein the polarity conversion control circuit is on a separate chip relative to the current direction chip.

6. The bistable pulse solenoid valve control system of claim 1, further comprising an analog to digital conversion circuit configured to receive the output current from the drive current sampling detection circuit, to convert the current to a digital value, and to send the digital value back to the main control circuit.

7. The bistable pulse solenoid valve control system of claim 1, wherein the drive current sampling detection circuit is configured to detect current changes, and to interpret the current changes to detect abnormal conditions of the bistable pulse solenoid valve.

8. The bistable pulse solenoid valve control system of claim 7, wherein the current sampling detection circuit is configured to detect when the valve core is blocked halfway such that the valve core no longer moves, to detect when conditions exist within the system such that the coil is powered off, and to detect when conditions exist within the system leading to a short circuit.

9. The bistable pulse solenoid valve control system of claim 1, wherein the coil includes a magnetic core, the magnetic core configured to increase the magnetic flux generated by the coil, and to change the magnetic flux of the coil.

10. The bistable pulse solenoid valve control system of claim 1, configured to open the bistable pulse solenoid valve in approximately 8 ms, and to close the bistable pulse solenoid valve in approximately 7 ms.

11. An automated water spray device, comprising:
a bistable pulse solenoid valve control system, comprising:
a bistable pulse solenoid valve having a coil current, the bistable pulse solenoid valve comprising:
a coil frame having at least two sides, and having an external wall;
a coil having a magnetic flux, the coil being wrapped around the external wall of the coil frame;
at least two permanent magnets disposed at least at two opposite sides of the coil;
a valve core disposed inside the coil frame;
a frame configured to encapsulate the permanent magnets, the coil, the valve core, and the coil frame;
a main control circuit, the main control circuit configured to receive induction signals and to transmit pulse signals;
a polarity conversion control circuit configured to receive pulse signals from the main control circuit, and to change the voltage direction of the coil based on the polarity of the pulse signals, thereby changing the current direction in said coil;
a drive current sampling detection circuit configured to read and collect the values of the current passing through the bistable pulse solenoid valve, and to develop sampling results;
wherein the main control circuit is configured to receive the sampling results, and to generate a corresponding control signal; and
wherein the polarity conversion control circuit is configured to receive the control signal, and to control the direction and power on-off time of the coil current based on the control signal

12. The automated water spray device of claim 11, the bistable pulse solenoid valve control system further comprising:
a first inflection point A, being the instant current generated when the valve core begins to move from the first end of the frame;
a second inflection point B, being the instant current when the valve core stops at the second end of the frame opposite to the first end; and
wherein the main control circuit is configured to transmit a corresponding control signal to the polarity conversion control circuit at the moment of the second inflection point B, and subsequently the polarity conversion control circuit is configured to turn off the power to the bistable pulse solenoid valve.

13. The automated water spray device of claim 11, wherein the automated water spray device is a faucet.

14. The automated water spray device of claim 11, wherein the automated water spray device is a toilet.

15. A method for controlling the direction and on-off time of the coil current of a bistable pulse solenoid valve, comprising:
providing a bistable pulse solenoid valve having a coil current, the bistable pulse solenoid valve comprising:
a coil frame having at least two sides, and having an external wall;
a coil having a magnetic flux, the coil being wrapped around the external wall of the coil frame;
at least two permanent magnets disposed at least at two opposite sides of the coil;
a valve core disposed inside the coil frame;
a frame configured to encapsulate the permanent magnets, the coil, the valve core, and the coil frame;
receiving induction signals by a main control and then transmitting pulse signals;
receiving the pulse signals from the main control circuit by a polarity conversion control circuit, and changing the voltage direction of the coil based on the polarity of the pulse signals, thereby changing the current direction in the coil;
collecting and reading the current passing through the bistable pulse solenoid valve by using a drive current sampling detection circuit, and developing sampling results;
interpreting the sampling results and generating a corresponding control signal by using the main control circuit; and
controlling the direction and on-off time of the coil current of the bistable pulse solenoid valve by using the polarity conversion control circuit to receive and interpret the control signal.

16. The method of claim 15, further comprising:
providing a first inflection point A, being the current generated after the coil is powered on, and when the valve core begins to move from the first end of the frame;
providing a second inflection point B, being the instant current when the valve core stops at the second end of the frame opposite to the first end; and
transmitting a corresponding control signal to the polarity conversion control circuit at the moment of the second inflection point B, and subsequently using the polarity conversion control circuit to turn off the power to the bistable pulse solenoid valve.

17. The method of claim 15, further comprising converting the output current from the drive current sampling detection circuit by an analog to digital conversion circuit to obtain a digital quantity, and feeding the digital quantity back to the main control circuit.

18. The method of claim 15, further comprising detecting abnormal changes of the current with the drive current sampling detection circuit, and thereby detecting abnormal conditions of the bistable pulse solenoid valve.

19. The method of claim 18, wherein the drive current sampling detection circuit detects when the valve core is blocked halfway such that the valve core no longer moves, when conditions exist within the system such that the coil is powered off, and when conditions exist within the system leading to a short circuit.

20. The method of claim 15, further comprising opening the bistable pulse solenoid valve in less than approximately 8 ms, and closing the bistable pulse solenoid valve in less than approximately 7 ms.
